(19) United States
(12) Patent Application Publication
(10) Pub. No.: US 2007/0131307 A1
(43) Pub. Date: Jun. 14, 2007

(54) Faux bamboo shade and method of making same

(76) Inventor: Ming Nien, Changhua Hsien (TW)

Correspondence Address: BUCHANAN INGERSOLL & ROONEY PC, P.O. BOX 1404, ALEXANDRIA, VA, 22313-1404, US

(21) Appl. No.: 11/297,680

(22) Filed: Dec. 8, 2005

(51) Int. Cl. B27J 7/00; B27G 1/00; B27M 1/00; B27D 1/04; B27G 11/00

(52) U.S. Cl. 144/333; 144/332; 144/380

(57) ABSTRACT

A faux bamboo shade is formed from a panel of faux bamboo slats. The faux bamboo slats are elongated, preferably plastic, strips having a front face and a rear face. At least one face of each strip is printed with an array of colors selected and applied to simulate color and texture of a real bamboo slat. These strips may be printed or deformed to simulate a grain pattern and at least one bamboo knot. The plastic strips may also be printed in a manner to simulate a scorch pattern.

### FIELD OF INVENTION

The present invention relates to a window coverings, particularly bamboo blinds, and methods of fabricating slats for such blinds.

### BACKGROUND OF THE INVENTION

Conventional bamboo shades are made from a panel of slats that have been cut from bamboo plants, treated and woven together. In some panels cylindrical rods or sticks are placed between each pair of slats. This panel is attached to a headrail and lift mechanism forming a roll-up shade or a roman shade.

The manufacture of bamboo slats from bamboo plants is a tedious process. First, one must find bamboo stalks suitable for use in a bamboo shade. The desired characteristics include a smooth surface and uniform colors on the surface. Raw bamboo rods with obvious color variations caused by exposure to sunlight, insect activity or other damage are excluded. Having found bamboo stalks or rods having the desired characteristics one must then cut the rods into sections based upon the desired length or width of the finished products. The cut sections must then be cleaned in a hot base solution. A typical cleaning process begins by boiling water in a large pot having a depth and diameter of from 0.8 to 3 meters. Once the water is boiling one kilogram of sodium hydroxide is added. The bamboo sections are boiled in the pot for 30 minutes with the solution temperature being maintained at 70° C. Then the bamboo sections are removed from the pot and wiped with a towel. Sometimes bamboo will discolor or change shape during the boiling step. Therefore, each section must be carefully inspected after being dried. In some bamboo shades a scorch pattern, also called a tortoise pattern, is applied to the bamboo. To create the scorch pattern the cleaned bamboo rod sections are placed side-by-side on the ground or other surface. Then water, sand, soil or combinations of these materials are randomly spread to cover portions of the raw bamboo rods. The rods are then exposed to a gas burner or torch scorching the uncovered portions of the rods. The covered portions will retain the original raw bamboo coloring while the uncovered portions will be black or dark brown. This arrangement of scorched and original surfaces is the tortoise pattern. The bamboo rods which may or may not have been scorched must next be cut longitudinally to form strips of bamboo having a desired width. These cut strips are called bamboo slats. Depending upon the type of product in which the slats are to be used, holes may be punched in the slats. Next, the slats are boiled in a solution of hydrogen peroxide and water for 30 minutes and removed for drying under the sun or baking in a furnace or oven. The baking process will result in a greenish color finish while sun drying produces a yellowish color finish on the slats Somewhat similar processes may include bonding the bamboo strips into a bamboo plate and coating the bamboo slats with a base coating and a face coating on the base coating such as are disclosed by Chen et al. in U.S. Pat. No. 5,896,903 and Nien in U.S. Pat. Nos. 6,192,949 and 6,746,745.

The traditional processes used to make bamboo slats are slow and complicated. A significant amount of chemical wastes, as well as bamboo plant waste, is generated as a by-product of the manufacturing process. The chemicals used to clean and remove grease from real bamboo slats during the manufacturing process are hazardous to the health of the worker. These environmental and health concerns have propelled the art to develop faux bamboo shades.

The faux bamboo shades which have been developed are comprised of a panel of plastic slats, and optionally plastic rods, woven together in the same manner as the slats in a real bamboo shade. This panel is attached to a headrail and lift mechanism in the same way as in a real bamboo shade. The slats in the faux bamboo shades currently available are extruded from a colored plastic material giving the slat a uniform color and appearance. Although this shade is called a faux bamboo shade, or even a bamboo shade, it does not look like a real bamboo shade. Real bamboo slats are not uniform in color or shape. They have grain patterns and vary in color from light yellows, greens and tans to light brown along the slat. Scorched slats have medium to dark brown and black color patterns. Real bamboo slats also have knots. These knots are raised portions extending across the slat that are about 5 millimeters in width and up to 2 mm in height. Such knots are typically lighter in color than the region on either side of the knot. The faux bamboo shades known in the art do not have knots or simulated knots and have a uniform thickness along their lengths. Yet, another advantage of faux bamboo shades over real bamboo shades is that they do not absorb moisture and can be cleaned by dipping them into a tub of soap and water. When a real bamboo slat absorbs or loses moisture, the slat tends to arch or bow. Such bowing does not occur in faux bamboo slats. Another advantage of faux bamboo slats over real bamboo is that faux bamboo slats can be cut more easily, being less likely to split or crack during cutting. Faux bamboo will not have mold or fungus growth such as occurs in real bamboo when exposed to moisture. Faux bamboo slats do not attract bugs and small critters. Faux bamboo can be fire retardant. Fire retardant additives can be added to the material from which the slats are extruded. Real bamboo burns easily.

Many home centers carry standard sizes of venetian blinds which can be trimmed to smaller widths using cut down machines located in the store. Because real bamboo slats can crack or chip during cutting, real bamboo shades are custom made by fabricators and blind manufacturers. There is no cut-down program currently available for bamboo shades. Faux bamboo slats can be more easily cut than real bamboo slats. Indeed, some cut-down machines currently being used for venetian blinds could make clean cuts on faux bamboo slats. Consequently, faux bamboo slats provide an opportunity for manufacturers to offer cut-down programs of the type currently being used to sell venetian blinds.

There is a need for a faux bamboo shade which has the advantages of the faux bamboo shades of the prior art yet looks like a real bamboo shade. Indeed, a faux bamboo shade which is easily mistaken for real bamboo by the average observer would be a significant advance in the art.

### SUMMARY OF THE INVENTION

I provide faux bamboo slats, and a faux bamboo shade formed from a panel of such slats. The faux bamboo slats are plastic strips, preferably of polyvinylchloride, having a front face and a rear face wherein at least one face is printed with an array of colors selected and applied to simulate color and texture of a real bamboo slat. These strips may be printed or deformed to simulate at least one bamboo knot. Typically, that knot will have a width of 3 to 5 millimeters.

I further provide a method for making faux bamboo slats in which a plurality of plastic strips are run through an imprint machine having at least one print roller. The print roller or rollers are inscribed to apply a pattern to the plastic strips which simulates grain patterns and color variations from light yellows, greens and tans to light brown found in real bamboo slats. As the strips are fed through the imprint machine the pattern is printed on at least one face of each strip. Then the strips are dried, completing the process of making the faux bamboo slats. These slats can be assembled into a panel of faux bamboo slats for use in a bamboo shade. That shade may be a roll-up shade or a roman shade. These slats may also be used in shutters, sliding panels and anywhere real bamboo slats have been used.

I prefer to feed several strips in a side by side arrangement through the imprint machine. Then the pattern need not be the same on every strip. I also prefer to either print or deform at least some of the strips in a manner to simulate a bamboo knot. The strips are preferably made of polyvinylchloride.

I prefer to extrude the plastic strips which are used for the faux bamboo slats. The extruder may have a die configured to create a grain pattern on the plastic slats.

I may create a grain pattern or knots or both on the plastic strips through embossing. This process uses a pair of spaced apart embossing rollers on which a grain pattern or knot pattern has been created.

Other objects and advantages of my faux bamboo slat and method of making the slat will become apparent from certain present preferred embodiments thereof illustrated in the drawings.

### BRIEF DESCRIPTION OF THE FIGURES

FIG. 1 is a front view of a present preferred embodiment of a faux bamboo shade made in accordance with the present invention.

FIG. 2 is a perspective view of a section taken from the lower right hand corner of the faux bamboo shade shown in FIG. 1.

FIG. 3 is a perspective view of a portion of one embodiment of a slat which can be used in the bamboo shade shown in FIG. 1.

FIG. 4 is a perspective view of a portion of an imprint machine imprinting a pattern on plastic strips in accordance with the present invention.

FIG. 5 is a perspective view of a plastic strip being extruded in accordance with one embodiment of the present method.

FIG. 6 is a perspective view of a portion of embossing rollers and a plastic slat after being embossed in accordance with another embodiment of the present method.

FIG. 7 is a front view of a shutter in which faux bamboo slats are provided in the shutter panels.

### DESCRIPTION OF THE PREFERRED EMBODIMENTS

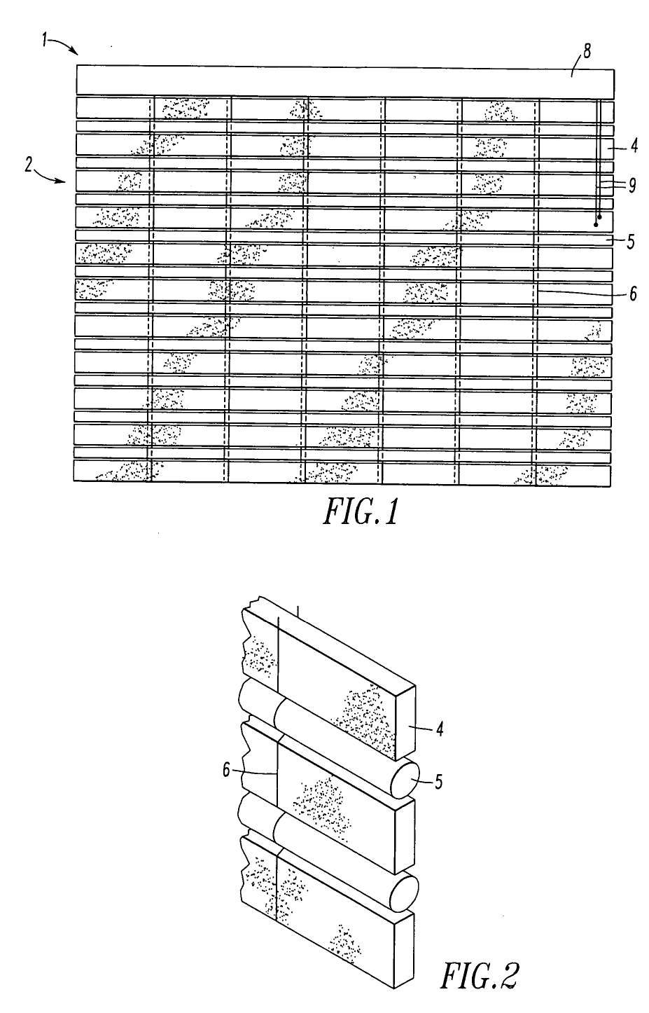

Referring to FIGS. 1 and 2, a first present preferred embodiment 1 of the bamboo shade is comprised of a panel 2 of the faux bamboo slats 4 and sticks 5 woven together with cords 6. The panel is connected to a headrail 8 containing a lift mechanism which includes lift cords 9. The lift mechanism may cause the panel 2 to be rolled up and down forming a roll-up shade. Alternatively, the lift mechanism may be connected in a manner to create a roman shade.

The slats 4 are imprinted in a manner to simulate the grain patterns and colors found in real bamboo slats. In a present preferred embodiment shown in FIGS. 1 and 2, the front face of the slats is imprinted with a scorch pattern. Preferably, the scorch pattern had been created from a real bamboo shade to which a scorch pattern has been applied in a traditional manner. The scorch patterns, grain patterns and color patterns of real bamboo may be printed on only the front face of the slats or on both the front face and the rear face of each slat. If only the front face of the slats is printed as simulated real bamboo, the rear face can be painted or left unpainted as desired. The slats themselves are preferably formed of a plastic such as polyvinyl chloride. However, it may be possible to use aluminum and some composite materials for these slats.

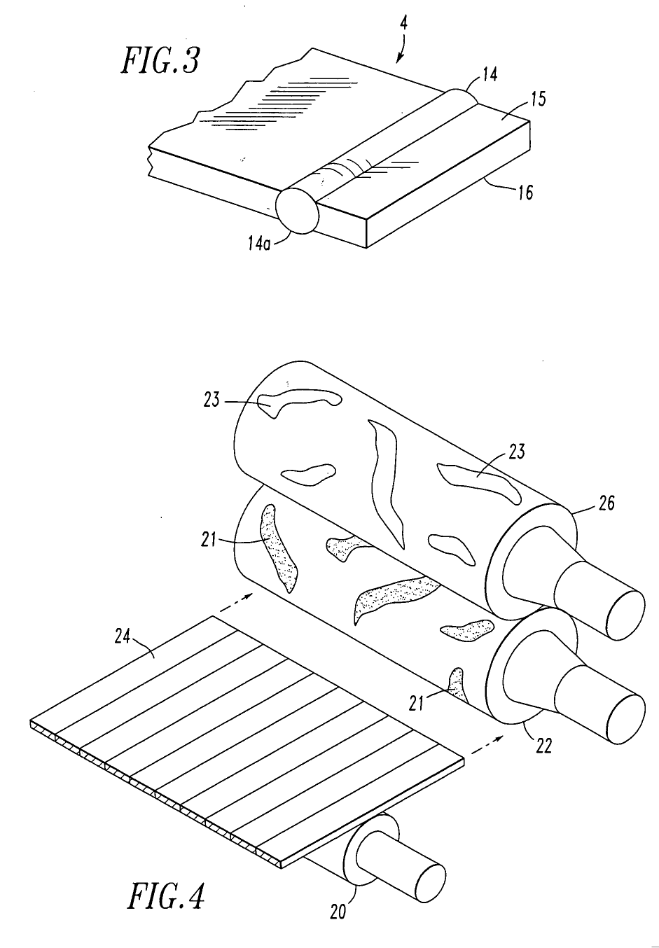

Referring now to FIG. 3, the slat 4 has been deformed to create a raised portion 14 across the width of the slat. This raised portion may be provided only on the front face 15 of the slat. Alternatively, the knot may also be provided on the back face 16 as indicated by dotted line 14a. The knot can be formed into the slat during the forming process. It is possible to create knot 14 by applying a plastic or other material to flat face of a standard slat so as to create the knot. It is also possible to form knots on one face of the slat using a calendaring or embossing process such as is illustrated in FIG. 6. Typically, the knot will have a width of 3 to 5 millimeters and extend a distance of not more than 2 millimeters above the surface 15 of the slat.

Referring to FIG. 4 the slats 4 are formed by providing a series of plastic strips 24 positioned in a side-by-side relationship. The slats are fed between a feed roller 20 and image transfer roller 22. The image roller contains the pattern which is printed onto the plastic strips. This pattern may be formed by raised portions on the roller or by depressions cut into the roller. Here the term inscribed is used to mean a process which creates the raised portions on the roller and a process which cuts or engraves the pattern into the roller. I prefer to engrave the desired pattern on a metal roller 26 to a depth of approximately 50 to 60 microns. Ink is applied to the engraved roller 26 filling the engraved portions 23. This ink 21 is then transferred onto a rubbery print roller 22. The ink 21 on the print roller 22 forms a pattern which simulates a grain pattern and preferably also a scorch pattern to be printed onto the plastic strips 24. Ink is applied from the rubbery roller 22 onto the slats. Although I have illustrated a single engraved roll and print roll combination in FIG. 4, those skilled in the art will recognize that printing of multiple colors onto the strips 24 may be done using several print rollers each applying a different color or pattern to the strips. Printing machines of the type used to print wooden, acrylic and aluminum plates, sheets and planks can be used for this process. After the plastic strips 24 have been printed with a pattern simulating real bamboo, they are dried.

The printing process enables one to create a wide array of colors and patterns from light yellows, greens and tans to light brown. Consequently, one is able to achieve a variety of bamboo appearances. A slat intended to depict raw bamboo will have more green shades than a slat intended to depict treated or processed bamboo. One can also replicate different species of bamboo through the choice of colors and patterns to be printed onto or formed into the plastic strips.

FIG. 4 illustrates only one face of the plastic strips being printed. If desired the same strips can be turned over and run through the printing process again to print the opposite face. Alternatively, the imprint machine could be configured to print both faces of the strips simultaneously or in sequence. After the printing process is completed, the strips, now faux bamboo slats, can be woven together to form a bamboo panel such as panel 2 shown in FIG. 1. The panel may be formed by placing sticks 5 between adjacent slats 4. Alternatively, one may form a panel by using only the faux bamboo slats. The sticks may be made of the same plastic material as the plastic strips which are printed to form the bamboo shafts. Such sticks typically would be extruded and need not be painted or printed. The diameter of the sticks should correspond to the width of the edge of the slats. Typically, that width is about a third to a fourth of the width of the front and rear surfaces of the slat.

Because real bamboo shades having a scorch pattern are popular in the marketplace, I prefer that the faux bamboo shades also have a scorch pattern. As can be seen in FIG. 1, the scorch pattern is not the same on each slat. Therefore, I prefer to print a plurality of slats simultaneously as shown in FIG. 4. In order to create a realistic scorch pattern on faux bamboo shades of the present invention I have taken a real bamboo shade, or set of unwoven real bamboo slats, to which a scorch pattern has been applied. From that shade or set of slats I have created an image of the scorch pattern. Then, I have used that image to inscribe the scorch pattern on the engraved roll 26 shown in FIG. 4. The scorch pattern preferably is converted to a digital image. That digital image is used by the engraver to operate a computer controlled engraving machine that inscribes the image into the engraved roller 26.

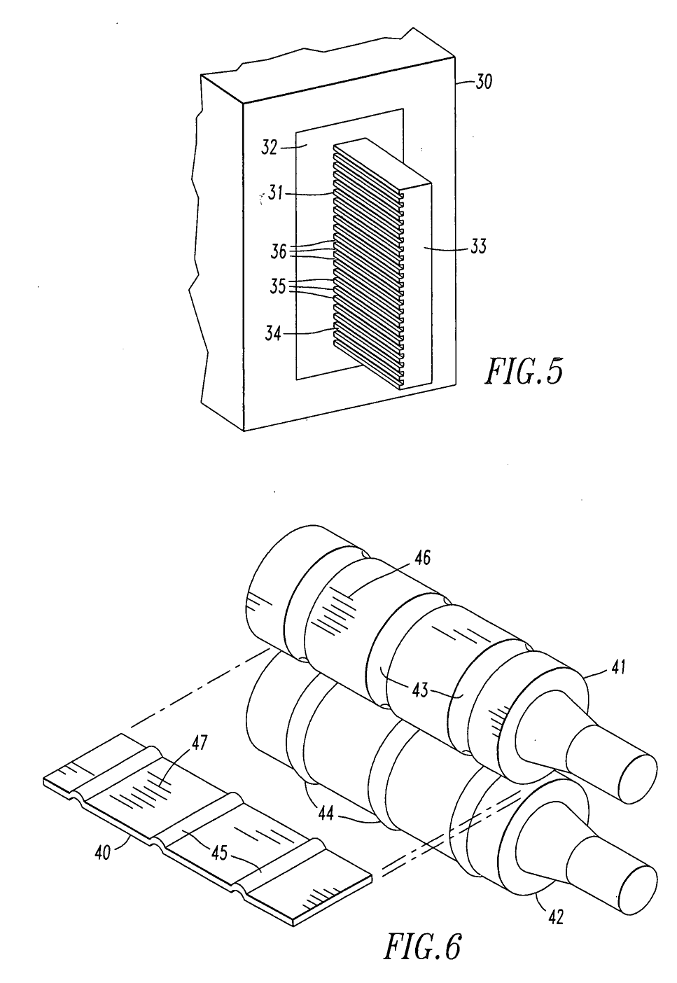

Although I prefer to print the grain pattern on the plastic strips, one could create a grain pattern during the extrusion process. In FIG. 5 an extruder 30 has an extrusion die 32. The side 31 of the die which forms the face 34 of the plastic strip 33 to be printed has grooves 36. As the plastic is extruded the grooves create raised ridges 35 on the face 34 of the plastic strip that simulate a grain pattern. It may be possible to use a darker color for these ridges by extruding a darker plastic. One might also achieve a darker color in the ridges by exposing them to heat causing the ridges to melt and change color. One can provide projections in the side 31 of the die to cut grooves into the face 34 of the plastic strip and simulate a grain pattern.

Another way to create a grain pattern in a plastic strip is by embossing the strip. FIG. 6 shows two spaced apart embossing rollers 41 and 42. One roller 41 has circumferential grooves 43 that are aligned with circumferential ridges 44 in the second roller 42. As the plastic strip 40 passes between the rollers 41, 42, knots 45 are formed in the strip 40. One or both embossing rollers may also be inscribed to create grooves or projections 46 along the length of the rollers. As the slat presses between the rollers the grooves or projections 46 will form a grain pattern 47 in the slat. One could provide mating ridges and grooves in rollers 20 and 22 shown in FIG. 4 to create knots in strips 24.

The extruded strip 33 or embossed strip 40 may then be printed as illustrated in FIG. 4 to provide the array of colors found in real bamboo. The same strip can be both extruded as in FIG. 5 and embossed as illustrated in FIG. 6. If desired, strips 33, extruded as illustrated in FIG. 5, and the embossed strips 40 could be used in a blind panel of the type shown in FIG. 1 without being printed or otherwise processed. The embossed strips 40 and extruded slats 33 could be painted before being assembled into a blind panel.

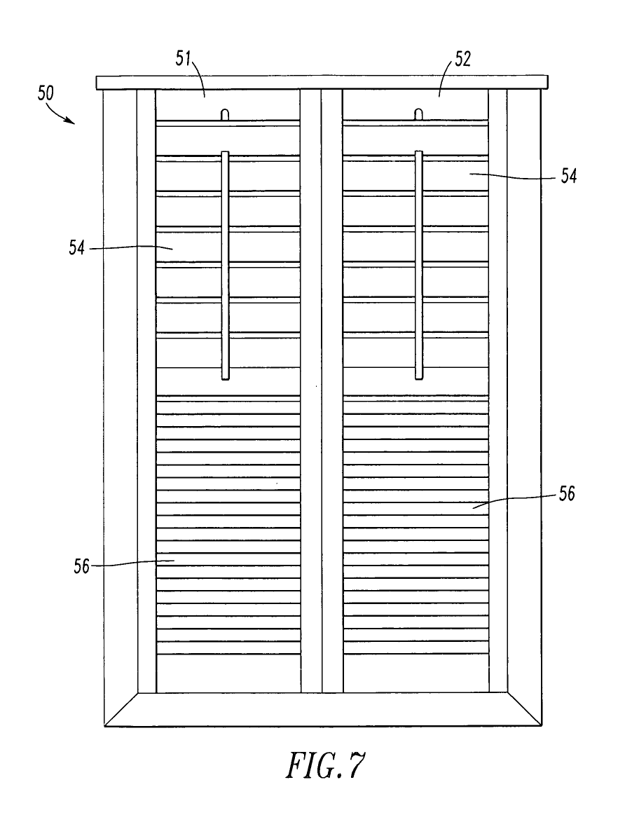

The faux bamboo slats made in accordance with the present invention have thus far been described and illustrated as being used in roll-up and roman shades. But, their use is not so limited. The slats could be used in venetian blinds, shutters, movable and decorative panels, wall hangings and other applications in which real bamboo slats have been used. FIG. 7 shows a shutter 50 having two shutter panels 51, 52. The louvers 54 in the shutter panels may be faux bamboo slats. One can also use the faux bamboo slats in the woven panels 56 provided in the lower portion of each shutter panel 51, 52.

Although I have shown and described certain present preferred embodiments of my faux bamboo shade and method of making the same, it should be distinctly understood that the invention is not limited thereto, but may be variously embodied within the scope of the following claims.

1. A faux bamboo slat comprising an elongated strip having a front face and a rear face wherein at least one face is printed with an array of colors selected and applied to simulate color and texture of a real bamboo slat.

2. The faux bamboo slat of claim 1 wherein the slat is printed in a manner so as to simulate at least one bamboo knot.

3. The faux bamboo slat of claim 2 wherein the knot has a width of 3 to 5 millimeters.

4. The faux bamboo slat of claim 1 also comprising a raised portion one at least on of the front face and the rear face of the strip, the raised portion sized and configured to simulate a bamboo knot.

5. The faux bamboo shade of claim 4 wherein the raised portion was formed by embossing.

6. The faux bamboo slat of claim 1 also comprising a scorch pattern printed on at least one of the front face and the rear face.

7. The faux bamboo slat of claim 1 wherein the strip is plastic.

8. The faux bamboo slat of claim 7 wherein the plastic is polyvinylchloride.

9. The faux bamboo slat of claim 1 wherein the strip has been extruded.

10. The faux bamboo slat of claim 9 wherein a grain pattern was created on the strip.

11. The faux bamboo slat of claim 1 also comprising a plurality of additional bamboo slats of the type claimed in claim 1, all woven together to form a panel.

12. A method for making faux bamboo slats comprising:
a. providing a plurality of strips;
b. providing an imprint machine having at least one print roller, the at least one print roller inscribed to apply a pattern to the plastic strips which simulates grain patterns and variations of color ranging from at least one of light yellows, greens and tans to light brown found in real bamboo slats;
c. feeding the plurality of strips through the imprint machine to cause the pattern to be printed on at least one face of each strip of the plurality of strips; and
d. drying the plurality of strips.

13. The method of claim 12 wherein the plurality of strips are printed simultaneously.

14. The method of claim 12 wherein the plurality of strips are printed sequentially.

15. The method of claim 12 wherein a portion of at least one of the plurality of strips is printed to simulate a bamboo knot.

16. The method of claim 12 wherein the strips are polyvinyl chloride.

17. The method of claim 12 wherein the strips have a front face and a rear face and the pattern is printed on both the front face and the rear face.

18. The method of claim 12 also comprising:
a. selecting a panel of real bamboo slats having a scorch pattern;
b. creating an image of the scorch pattern; and
c. inscribing the image of the scorch pattern on the at least one print roller such that the image of the scorch pattern forms a portion of the pattern that is printed onto the plurality of strips.

19. The method of claim 12 also comprising forming a raised portion on at least one of the plurality of strips in a manner to simulate a bamboo knot.

20. The method of claim 19 wherein the raised portion is formed by embossing.

21. The method of claim 12 also comprising assembling the plurality of strips which have been printed into a panel.

22. The method of claim 12 wherein the plurality of strips have been formed by extrusion.

23. The method of claim 22 wherein a grain pattern is formed on the strips during extrusion.

24. The method of claim 22 also comprising embossing the strips.

25. An improved bamboo shade of the type consisting of a panel comprised of faux bamboo slats connected to a headrail and lift mechanism wherein the improvement comprises the faux bamboo slats each comprised of an elongated strip having a front face and a rear face wherein at least one face is printed with an array of colors selected and applied to simulate color and texture of a real bamboo slat.

26. The improved faux bamboo shade of claim 25 wherein at least one strip is printed in a manner so as to simulate at least one bamboo knot.

27. The improved faux bamboo shade of claim 26 wherein the knot has a width of at least 3 to 5 millimeters.

28. The improved faux bamboo shade of claim 25 also comprising a raised portion on at least one of the front face and the rear face of at least one faux bamboo slat, the raised portion sized and configured to simulate a bamboo knot.

29. The improved faux bamboo shade of claim 28 wherein the raised portion was formed by embossing.

30. The improved faux bamboo shade of claim 25 also comprising a scorch pattern printed on at least one of the front face and the rear face of at least one faux bamboo slat.

31. The improved faux bamboo shade of claim 25 wherein the strip is plastic.

32. The improved faux bamboo shade of claim 31 wherein the plastic is polyvinylchloride.

33. The improved faux bamboo shade of claim 25 wherein the plastic strips have been extruded.

34. The improved faux bamboo shade of claim 33 wherein a grain pattern was formed on the plastic strip.
